(19) United States
(12) Patent Application Publication
(10) Pub. No.: US 2013/0179215 A1
(43) Pub. Date: Jul. 11, 2013

(54) RISK ASSESSMENT OF RELATIONSHIPS

(71) Applicants: Racquel Clough Foster, Dallas, TX (US); Gary Francis Page, Harrisburg, NC (US); Brett D. Briggs, Charlotte, NC (US); Amy Marie Williams, Maple Valley, WA (US); Jay C. DeDomenico, Yardley, PA (US); Stephen M. Miner, Waxhaw, NC (US)

(72) Inventors: Racquel Clough Foster, Dallas, TX (US); Gary Francis Page, Harrisburg, NC (US); Brett D. Briggs, Charlotte, NC (US); Amy Marie Williams, Maple Valley, WA (US); Jay C. DeDomenico, Yardley, PA (US); Stephen M. Miner, Waxhaw, NC (US)

(73) Assignee: Bank of America Corporation, Charlotte, NC (US)

(21) Appl. No.: 13/346,785

(22) Filed: Jan. 10, 2012

(51) Int. Cl. G06Q 10/00

(52) U.S. Cl. 705/7.28

(57) ABSTRACT

Assessing risks arising from relationships with third-parties that support the operations or strategic goals of an organization, such as a bank, are provided. A risk assessment system receives risk assessment values respectively corresponding to the likelihood, severity, and control for a risk item associated with a third-party relationship. The risk assessment system then determines a risk priority value for the risk item based on the risk assessment values. The risk assessment system may prioritize multiple risk items according to their respective risk priority values, risk categories, or both. In some arrangements, the risk assessment system may identify a risk item for additional risk mitigation and determine a risk mitigation action plan for the identified risk item.

### FIELD

Aspects of the disclosure relate to managing risk. More specifically, aspects of the disclosure relate to providing a risk assessment for relationships with other entities.

### BACKGROUND

With the rapid evolution of the financial services industry, an increasing number of banks are looking to third-party relationships as a way to improve financial performance, implement advanced technologies, leverage expertise, and specialize in core competencies. Indeed, third-party relationships can enhance a bank's product offerings, diversify assets and revenues, access superior expertise and industry best practices, devote human resources to core businesses, facilitate operations restructuring, and reduce costs. However, third-party relationships can increase a bank's risk profile, particularly strategic, reputation, compliance, and transaction risks. Consequently, bank management must engage in a rigorous analytical process to identify, measure, monitor, and establish controls to manage the risks associated with third-party relationships.

With traditional risk management systems, third party risk assessment is typically performed using only assessments of historical third-party information.

### SUMMARY

In accordance with various aspects of the disclosure, systems and methods are provided for assessing risks associated with third-parties and third-party relationships. The third-party may be, for example, a business or other entity that supports the operations or strategic goals of an organization, such as a bank. In some embodiments, aspects of the disclosure may be provided in a computer-readable storage medium having computer-executable instructions to perform one or more of the process steps described herein.

According to an aspect of the disclosure, a risk assessment computer system may receive risk assessment values respectively corresponding to the likelihood, severity, and control for a risk item associated with the third-party relationship. A risk item may be, for example, a risk associated with a third-party relationship. The risk assessment values may be received in response to user input. For example, the risk assessment values may be numerical values (e.g., integer values ranging from “1” to “5,” with greater values corresponding to greater risk levels) and may be received in response to input from one or more subject matter experts. The risk assessment computer may then calculate a risk priority value for the risk item based on the risk assessment values. For example, the risk priority value may be a risk priority number corresponding to the mathematical product of the risk assessment values (e.g., integer values ranging from “1” to “125,” with greater values corresponding to greater risk levels).

According to another aspect of the disclosure, the risk assessment system may prioritize risk items based on their respective risk priority values. For example, the risk assessment computer may identify risk items with greater than average risk priority values as high priority risk items, and risk items with less than average risk priority values as lower priority risk items.

According to another aspect of the disclosure, the risk assessment system may prioritize risk items based on their respective risk categories. Each risk item may be associated with a risk category, such as, for example, a credit risk category, a transaction risk category, a strategic risk category, a contractual risk category, a market risk category, a reputation risk category, or a combination of risk categories. For example, risk items may be prioritized by weighting their respective risk priority values with a weight value associated their respective risk categories.

According to another aspect of the disclosure, the risk assessment system may identify a risk item for additional risk mitigation based on its risk priority value. For example, the risk assessment system may identify a risk item for additional risk mitigation when its risk priority value exceeds a predefined threshold. In another example, the risk assessment system may identify a risk item for additional risk mitigation using a six sigma analytical technique. In certain embodiments, when a risk item is identified for additional risk mitigation, the risk assessment system may determine a risk mitigation action plan for the risk item.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the disclosure, as well as the following detailed description of illustrative embodiments, is better understood when read in conjunction with the accompanying drawings, which are included by way of example, and not by way of limitation with regard to the claimed subject matter.

FIG. 1 illustrates an example operating environment in which various aspects of the disclosure may be implemented.

FIG. 2 illustrates an example computing environment in which third-party risk may be assessed in accordance with some embodiments of the disclosure.

FIG. 3 illustrates an example user interface for providing risk assessment values and determining a risk priority value for a risk item in accordance with some embodiments of the disclosure.

FIG. 4 illustrates an example user interface for providing risk assessment values and determining risk priority values for a plurality of risk items in accordance with some embodiments of the disclosure.

FIG. 5 illustrates an example user interface for prioritizing risk items and identifying risk items for additional risk mitigation in accordance with some embodiments of the disclosure.

FIG. 6 is a flowchart illustrating an example method for determining a risk priority value for a risk item in accordance with some embodiments of the disclosure.

FIG. 7 is a flowchart illustrating an example method for determining whether to identify a risk item for additional risk mitigation in accordance with some embodiments of the disclosure.

FIG. 8 is a flowchart illustrating an example method for prioritizing risk items in accordance with some embodiments of the disclosure.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the claimed subject matter.

A risk assessment system may provide identification, assessment, disposition, monitoring, mitigation, and reporting of risk items associated with the third-party risk, such as risks arising from third-party relationships that support the operations or strategic goals of an organization. Third-party relationships are often used by organizations, such as banks, to provide particular products or services of strategic or operational importance. The assessment of risk arising from third-party relationships is important in assessing an organization's overall risk profile, such as whether the organization is assuming more risk than it can identify, monitor, manage, and control. For example, a bank may have a third-party relationship with a mortgage servicing company. Accordingly, the bank may assess the historical, current, or predicted risk associated with the third-party mortgage servicing company in accordance with the bank's own risk management, security, privacy, and other consumer protection policies as if the bank were conducting the mortgage servicing activities directly. The risk assessment system may also map known risk items into a standard risk framework, such as a risk management framework specified by the United States Office of the Comptroller of the Currency (OCC). The risk assessment system described herein may be used as a tool for organizations and adapted as necessary to reflect specific circumstances and individual risk profiles of varying scale and complexity.

The risk assessment system may assess individual risk items, combinations of risk items, or both based on various risk information, such as attributes, risk categories, risk assessment values, risk priority values, risk controls, risk mitigation action plans, characteristics about different risk frameworks, controls for reducing risk levels, and any other suitable information. For example, the risk assessment system may store a risk item in association with various attributes, such as name, identification number, risk assessment values, risk priority value, comments, controls, and other suitable information.

The risk assessment system may receive risk assessment values corresponding to the likelihood, severity, and control for a risk item. For example, the risk assessment system may receive the risk assessment values as input from a user, such as one or more subject matter experts, managers, analysts, line of business representatives, or board members. Severity may be, for example, the impact of the risk item on the organization's customers, reputation, earnings, legal, regulatory, and supply chain. Likelihood may be, for example, the probability that a loss or impact may occur. Control may be, for example, the ability to detect the risk item (or the effectiveness of a control environment) and mitigate its impact.

The risk assessment system may calculate a risk priority value for the risk item based on the risk assessment values. For example, the risk priority value may be a risk priority number (RPN) determined by calculating the mathematical product of the risk assessment values, with greater RPNs corresponding to greater levels of risk. In some arrangements, the risk assessment computer may also prioritize multiple risk items according to their respective risk priority values, risk categories, or both. Risk categories associated with each risk item may include, for example, credit risk, transaction risk, strategic risk, contractual risk, market risk, reputation risk, or any other suitable risk or a combination of risks. The risk assessment system may also identify risk items for additional risk mitigation and determine risk mitigation action plans for the identified risk items.

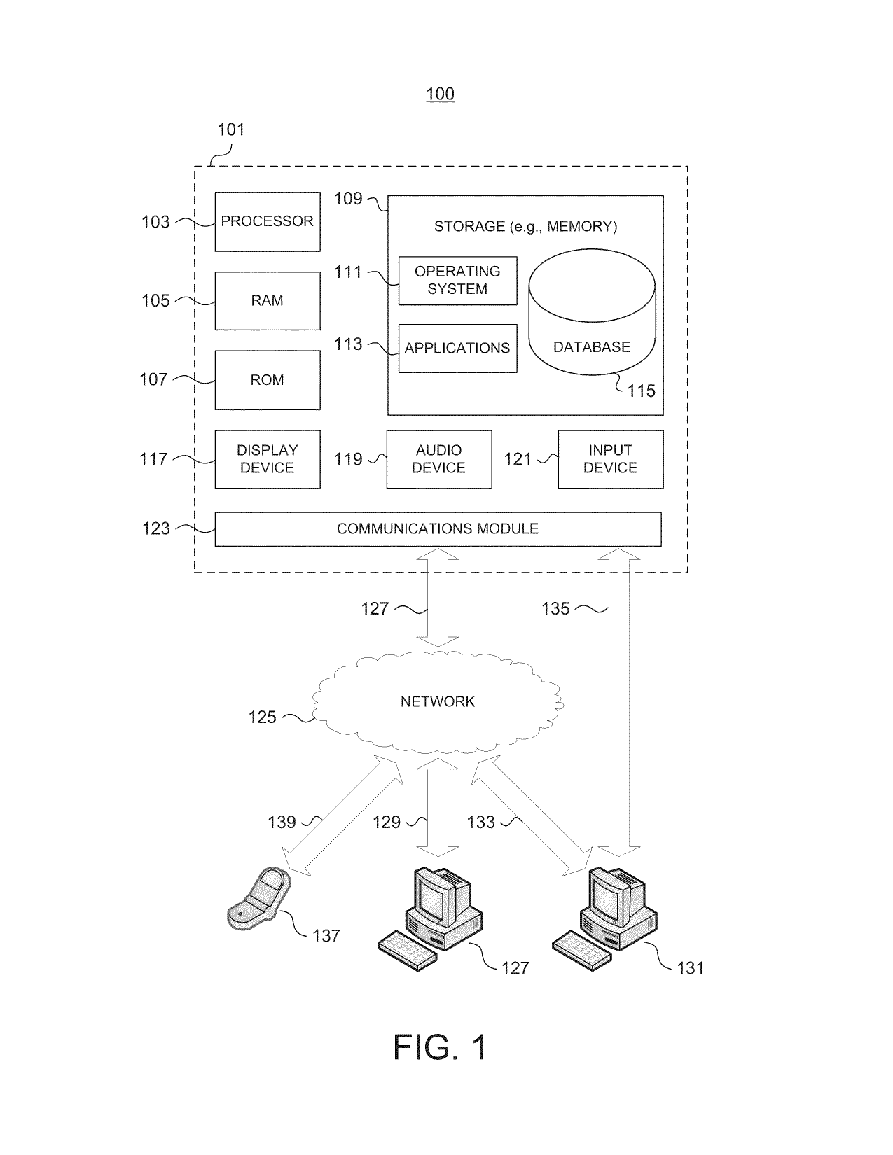

FIG. 1 illustrates an example of a computing system 100 in which one or more aspects described herein may be implemented. Computing system 100 is only one example of a suitable computing environment and is not intended to suggest any limitation as to the scope of use or functionality of the disclosure. The disclosure is operational with numerous other general purpose or special purpose computing environments or configurations, such as personal computers, server computers, hand-held or laptop devices, tablet computers, multiprocessor systems, microprocessor-based systems, set top boxes, programmable consumer electronics, network PCs, minicomputers, mainframe computers, distributed computing environments, and other suitable computing systems and combinations of computing systems.

Computing system 100 may include computing device 101 wherein the processes discussed herein may be implemented. Computing device 101 may house a variety of components for inputting, outputting, storing and processing risk information (e.g., risk item attributes, risk categories, risk assessment values, risk priority values, risk controls, risk mitigation action plans, etc.) and other data. For example, computing device 101 may include processor 103 for executing one or more applications, retrieving data from a storage device, outputting data to a device, or performing any other suitable process. Processor 103 may be communicatively coupled to Random Access Memory (RAM) 105 in which application data, instructions, or other computer-readable media may be temporarily stored and accessed. Computing device 101 may further include Read Only Memory (ROM) 107 which allows data and computer-readable media stored thereon to persist after computing device 101 has been turned off. ROM 107 may be used for a variety of purposes including storage of a Basic Input/Output System (BIOS) for computing device 101. ROM 107 may further store date and time information so that the information persists through power losses, shut downs, and reboots.

In some embodiments, computing device 101 may include storage 109. For example, storage 109 may provide long term storage for a variety of data including operating system 111, applications 113, and database 115. Storage 109 may include any of a variety of computer readable media such as disc drives, optical storage mediums, magnetic tape storage systems, flash memory and other suitable storage devices. In one example, processor 103 may retrieve an application from applications 113 in storage 109 and temporarily store the instructions associated with the application in RAM module 105 while the application is executing. In another example, some or all of the computer executable instructions for computing device 101 may be embodied in hardware or firmware, which is not shown to avoid overcomplicating the drawing. In certain embodiments, applications 113 may include computer executable instructions for performing risk management and third-party risk assessment. In certain embodiments, applications 113 may include computer executable instructions for invoking user functionality related to communication including email, short message service (SMS), and voice input and speech recognition applications. In certain embodiments, database 121 may provide centralized storage of risk information including attributes about risk items, characteristics about different risk frameworks, and controls for reducing risk levels that may be received from different points in system 100, such as computing devices 101, 127, 131, 137, or any other suitable device or combination of devices.

In some embodiments, computing device 101 may include display device 117 for displaying textual, audiovisual, graphical information, or any other suitable information, such as a graphical user interface (GUI). Display device 117 may be, for example, an internal or external monitor, television, or touch screen display that receives display data from, for example, processor 103. In certain implementations, computing device 101 may include one or more output device controllers, such as a video processor, for translating processor instructions into corresponding video signals for display by display device 117.

In some embodiments, computing device 101 may include audio device 119, such as a speaker, for outputting audio data and notifications provided by processor 103 or any other suitable device. In certain implementations, computing device 101 may include one or more output device controllers, such as an audio processor, for translating processor instructions into corresponding audio signals to be sounded by audio device 119.

In some embodiments, computing device 101 may include input device 121 for receiving input directly or indirectly from a user. Input device 121 may include, for example, a keyboard, a microphone, a touch screen display, a storage media drive, an optical scanning device, or any other suitable device for receiving user input. In certain implementations, computing device 101 may include one or more input device controllers for translating input data into computer readable or recognizable data. For example, voice input received from a microphone may be converted into a digital format and stored in a data file in RAM 105, ROM 107, storage 109, or any other suitable storage device. In another example, tactile input received from a touch screen interface may be converted into a digital format and stored in a data file. In another example, a physical file (e.g., paper documents, correspondence, receipts, etc.) may be scanned and converted into a digital file by an optical scanner and received as input. In certain implementations, a device such as a media drive (e.g., DVD-R, CD-RW, external hard drive, flash memory drive, etc.) may act as both an input and output device allowing a user to both write and read data to and from computing device 101.

In some embodiments, computing device 101 may include one or more communication components for receiving and transmitting data over a network. For example, computing device 101 may include communications module 123 for communicating with network 125 over communications path 127. Network 125 may include, for example, an Internet Protocol (IP) network, a wide-area network (WAN), a local-area network (LAN), a local wireless network (e.g., WiMAX), a digital broadcast network, a digital subscriber line (DSL) network, a frame relay network, an asynchronous transfer mode (ATM) network, a virtual private network (VPN), a cellular network, a telephone network, a fiber optic network, a satellite network, and any other suitable network or combination of networks. Communications path 127 may include any suitable wired or wireless communications path, such as a wide area network (WAN) path, a local area network (LAN) path, a cellular communications path, or any other suitable path. Communications module 123 may include the corresponding circuitry needed to communicate with network 125 and with other devices on the network. For example, communications module 123 may include a wired interface, wireless interface, or a combination of the two. In an illustrative example, communications module 123 may facilitate transmission of data such as electronic mail messages, financial data, or both over an organization's network. In another example, communications module 123 may facilitate transmission or receipt of information over the Internet. In some embodiments, communications module 123 may include one or more sets of instructions relating to one or more networking protocols. For example, communications module 123 may include a first set of instructions for processing IP network packets and a second set of instructions for processing cellular network packets.

In some embodiments, computing device 101 may operate in a networked environment supporting connections to one or more remote computing devices. For example, computing system 100 may include computing device 127 communicatively coupled to network 125 through communications path 129 (e.g., a WAN communications path), computing device 131 communicatively coupled to network 125 through communications path 133 (e.g., a WAN communications path), and computing device 137 communicatively coupled to network 125 through communications path 139 (e.g., a cellular carrier or WAN communications path). In certain implementations, computing device 131 may be directly communicatively coupled to communications module 123 in computing device 101 through communications path 135 (e.g., a LAN communications path). Computing devices 127 and 131 may be, for example, personal computing devices or servers and may include any of the elements described above with reference to computing device 101. Computing device 137 may be, for example, a portable computing device, such as a mobile communications device or tablet computer, and may include any of the elements described above with reference to computing device 101. Communications paths 129, 133, 135, and 139 may be any suitable communications path or paths, such as those described with reference to communications path 127.

It will be appreciated that the network connections shown are illustrative and other means of establishing a communications link between the computing devices may be used. The existence of any of various well-known protocols such as Transmission Control Protocol/Internet Protocol (TCP/IP), Ethernet, File Transfer Protocol (FTP), Hypertext Transfer Protocol (HTTP), Data Over Cable Service Interface Specification (DOCSIS) and the like is presumed, and the system can be operated in a client-server configuration to permit a user to retrieve web pages from a web-based server. Any of various conventional web browsers can be used to display, input, and manipulate data on web pages. The network connections may also provide connectivity to a closed-circuit television (CCTV) or an image capturing device, such as an iris or face recognition device.

Although not required, various aspects described herein may be embodied as a method, a data processing system, or a computer-readable medium storing computer-executable instructions. In some embodiments, a computer-readable medium storing instructions to cause a processor to perform steps of a method in accordance with aspects of the disclosure is contemplated. Aspects of the method steps disclosed herein may be executed on, for example, processor 103 in computing device 101. For example, processor 103 may execute computer-executable instructions stored on a computer-readable medium, such as RAM 105, ROM 107, storage 109, or any other suitable device or combination of devices.

One of skill in the art will appreciate that computing systems such as computing system 100 may include a variety of other components and are not limited to the devices and configurations described in FIG. 1.

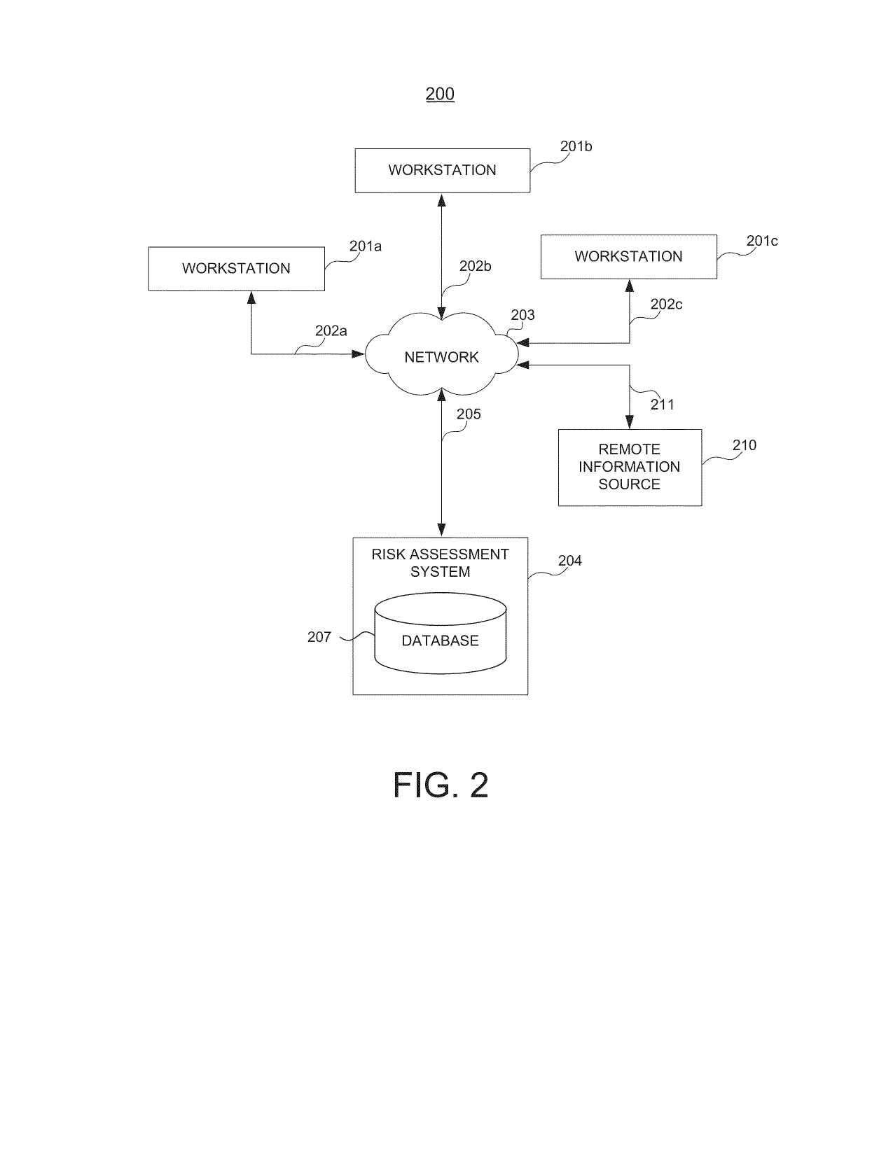

FIG. 2 illustrates an example computing system 200 in which third-party risk may be assessed according to some embodiments of the disclosure. As illustrated, system 200 may include one or more workstations 201 (e.g., workstations 201a, 201b, 201c), which may be any suitable computing device or devices, such as those described with reference to computing devices 101, 127, 131, and 137 shown in FIG. 1. Workstations 201 may be local or remote, and may be communicatively coupled by one or more communications paths 202 (e.g., 202a, 202b, 202c) to network 203. Network 203 may any suitable communications network, such as network 125 shown in FIG. 1, and may be communicatively coupled to risk assessment system 204 via communications path 205. Communications paths 202 and 205 may include any suitable communications path or paths, such as those described with reference to communications path 127 shown in FIG. 1.

Risk assessment system 204 may be any suitable data processing device (e.g., computing device 101 shown in FIG. 1) for assessing third-party risk and may include, or be communicatively coupled to, database 207 to receive, store, process, and output information. Database 207 may include, for example, any suitable combination of features described with reference to RAM 105, ROM 107, and storage 109 shown in FIG. 1. Risk assessment system 204, database 207, or both may be configured to offer any desired service and may run or support various computing languages and operating systems, such as Structured Query Language (SQL), Java Persistence Query Language (JPQL), Active Server Pages (ASP), Hypertext Preprocessor (PHP), JavaServer Pages (JSP), Microsoft Windows, Macintosh OS, Apache Tomcat, Unix, Berkeley Software Distribution (BSD), Ubuntu, Redhat Linux, Hypertext Markup Language (HTML), JavaScript, Asynchronous JavaScript and XML (AJAX), Comet, and other suitable languages, operating systems, and combinations thereof. Other types of database languages and structures may be used as desired or needed.

Database 207 may store risk information as well as other types of company or organization information, such as employee data, scheduling information, contractual information, market information, and legal and regulatory information. In certain embodiments, database 207 may store multiple data records with each record having multiple attributes. For example, if each record represents a risk item associated with a third-party relationship, the record attributes may include name, identification number, risk assessment values, risk priority value, comments, controls, and other suitable information.

In some embodiments, risk assessment system 204 may perform risk reporting, risk analysis reporting, or both. For example, risk assessment system 204 may provide risk reporting that may be filtered by risk category, risk priority value, date values, hierarchy, accountability, and other suitable factors. In another example, risk assessment system 204 may provide risk analysis reporting by mapping known risk items into frameworks (e.g., risk categories, processes), which may assist to identify trends and the highest areas of risk at any given point. In another example, the risk assessment system may provide customized reporting for a risk item by generating and transmitting an e-mail notification to relevant recipients when a new risk item is identified, when a risk item change status, or when a risk item's risk priority number exceeds a threshold (e.g., a predefined threshold, a weighted threshold, a threshold based on a running average of RPNs). The reporting may assist with enhancing the organization's third-party risk management.

In some embodiments, system 200 may include remote information source 210, which may be communicatively coupled to risk assessment system 204, workstations 201, or both through network 203. Remote information source 210 may be any suitable computing device (e.g., computing device 101 shown in FIG. 1) for receiving and/or providing any of the risk information and additional information described herein. For example, remote information source 210 may be a server, database, or both that includes information about or information maintained by a third-party being, such as a mortgage servicing company. Remote information source may be communicatively coupled to network 203 through communications path 211, which may include any suitable communications path or paths, such as those described with reference to communications path 127 shown in FIG. 1.

In some embodiments, users of workstations 201 may access risk assessment system 204 to request and retrieve risk information from risk assessment system 204, database 207, or both. For example, users of workstations 201 may access information associated with a specific risk item which they are responsible for assessing and input risk assessment information, such as risk assessment values and textual comments for the risk item. Workstations 201 may transmit the information to risk assessment system 204 over network 203. Risk assessment system 204 may process the received risk information to assess the risks associated with the third-party relationship, such as by determining risk priority values, prioritizing risk items, identifying risk items for additional risk mitigation, and determining risk mitigation action plans.

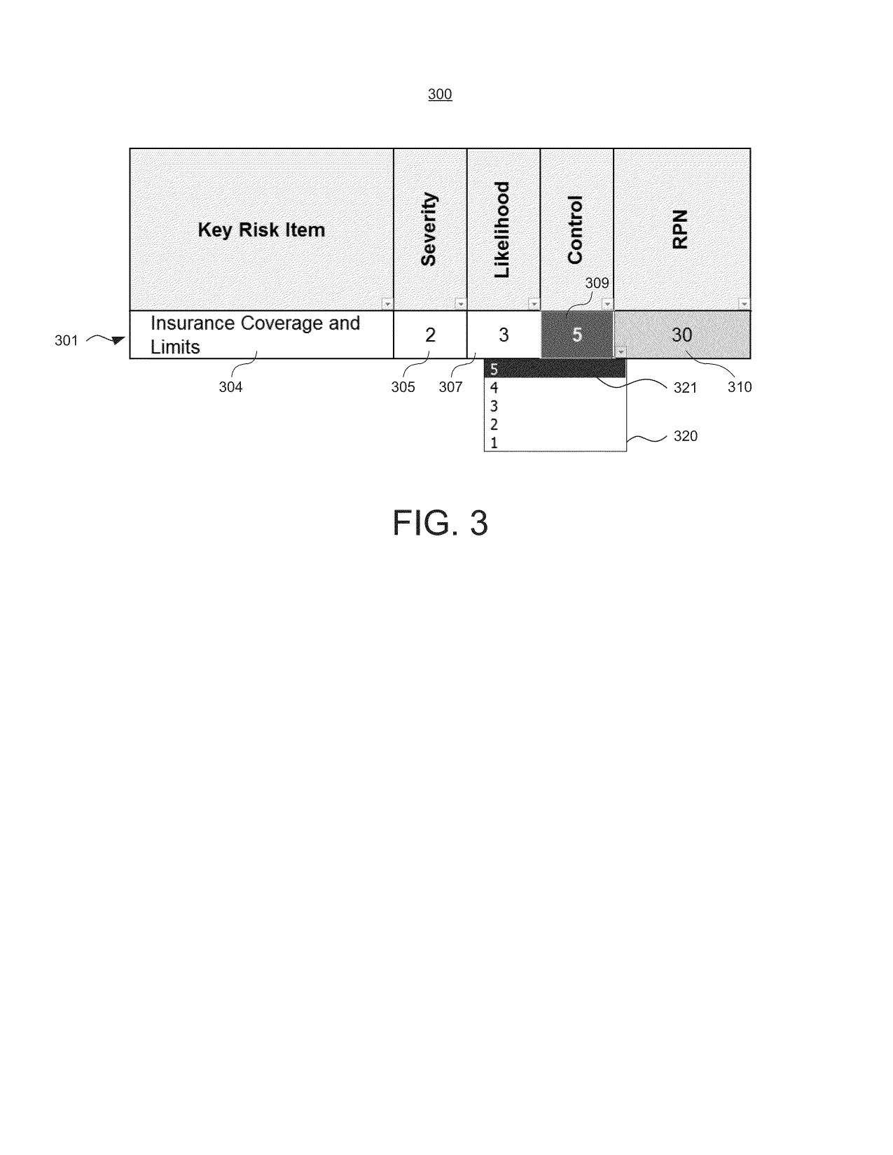

FIGS. 3-5 show illustrative user interfaces for displaying risk information and receiving input from users in accordance with aspects of the disclosure. The illustrative user interfaces of FIGS. 3-5 may be implemented by one or more of the components discussed with reference to FIGS. 1-2 or any other suitable component or combination of components. It will be appreciated that any feature discussed with reference to one of the user interfaces shown in FIGS. 3-5 may be partially or wholly implemented in any other user interface described herein.

FIG. 3 illustrates an example user interface 300 for providing risk assessment values and determining a risk priority value for a risk item in accordance with some embodiments of the disclosure. User interface 300 may be displayed on workstation 201 shown in FIG. 2 using, for example, display device 117 shown in FIG. 1. User interface 300 may include, for example, risk item 301, risk identification field 304, and selectable risk assessment fields 305, 307, and 309. Risk item 301 may be a new risk identified by a user or risk provided by, for example, risk assessment system 204 shown in FIG. 2. Risk identification field 304 may include a name, description, or other identifier indicative of risk item 301. In one example, a user may select and input a risk name, description, or other identifier for risk item 301 in risk identification field 304 (e.g., “Insurance Coverage and Limits”) using an input device, such as input device 121 shown in FIG. 1. In another example, risk identification field 304 may include information received from risk assessment system 204 or remote information source 210 shown in FIG. 2, and may or may not be editable by a user. In another example, user selection of risk identification field 304 may provide a pop-up window display, drop down display, or any other suitable display region that includes a list of pre-defined risk identifiers, one of which the user may select to populate risk identification field 304. This pop-up window display is not shown in FIG. 3 to avoid overcomplicating the drawing.

Severity risk assessment field 305 may include information indicative of the severity of risk item 301. Severity may be, for example, the impact or the severity of the effect of the risk item on customers, reputation, earnings, legal, regulatory, and supply chain as measured by a user or by an assessment of financial and other data performed the risk assessment system. For example, risk assessment system 204 shown in FIG. 2 may access and manipulate historical data stored in database 207, remote information source 210, workstations 201, or any other suitable information source to determine the severity risk assessment value or any other risk assessment value.

In certain embodiments, the severity risk assessment value may be a numeric value (e.g., an integer value ranging from “1” to “5”), with greater values corresponding to greater risk levels. For example, severity may correspond to a potential amount of lost revenue, a potential decrease in the number of people having a favorable opinion of the organization, or any other suitable metric. In some arrangements, the severity risk assessment values may correspond to a severity rating scale in which: “5” indicates that the risk significantly impacts or has the potential to significantly impact the business and/or strategies of the organization; “4” indicates that the risk has a considerable impact or the potential to considerably impact the business and may have broader implications across other lines of business; “3” indicates that the risk has a noticeable impact or the potential to noticeably impact the business; “2” indicates that the risk has low level of impact or the potential for low impact to the business; and “1” indicates that the risk has virtually no impact to the business functions or practices.

In certain implementations, a severity risk assessment value may correspond to a potential impact (e.g., amount of lost revenue, decrease in the number of people having a favorable opinion of the organization) exceeding a threshold value. The threshold value may be an average value (e.g., an arithmetic, geometric, or harmonic mean, median, or mode) or a running average value of one or more of the attributes of risk item 301. For example, the threshold value may be a percentage of the running average value of the organization's quarterly revenue, projected revenue, or both over a particular period of time. In some embodiments, the threshold value may be weighted by the organization's risk appetite, risk tolerance, or any other suitable parameter. For example, the threshold value may be increased by a certain amount or percentage for an organization with a lower risk tolerance level for third-party risks. In another example, risk items associated with particular risk categories may have different threshold values in response to, for example, one risk category being assigned a lower or higher risk tolerance than another risk category.

Likelihood risk assessment field 307 may include information indicative of the likelihood of risk item 301. Likelihood may be, for example, the probability that a loss or impact could occur. In certain embodiments, the likelihood risk assessment value may be a numeric value (e.g., an integer value ranging from “1” to “5”), with greater values corresponding to greater risk levels. For example, the likelihood risk assessment values may correspond to a likelihood rating scale in which: “5” indicates that the risk occurs repeatedly with regular opportunities for failure; “4” indicates that the risk occurs very frequently with numerous opportunities for failure; “3” indicates that the risk occurs frequently with several opportunities for failure; “2” indicates that the risk occurs occasionally with some opportunities for failure; and “1” indicates that the risk occurs very seldom with only one or a few opportunities for failure. In some arrangements, likelihood risk assessment field 307 may include features described with reference to severity risk assessment field 305. For example, a likelihood risk assessment value may be determined by comparing historical data to a threshold value.

Control risk assessment field 309 may include information indicative of the control of risk item 301. Risk control may be, for example, a method or technique to identify and evaluate potential risks and to mitigate the impact of such risks. In some embodiments, risk control may involve the implementation of new polices and standards, physical changes and procedural changes that mitigate certain risks within the business. For example, risk control may utilize findings from risk assessments identifying potential risk factors in an organization's or third-party's operations (e.g., technical and non-technical aspects of the organization, financial policies, and other policies that may impact the organization) and determining and implementing risk mitigation action plans or changes to control or mitigate risk in these areas. Risk controls may include, for example, an annual assessment, contractual notification requirement, management oversight, performance reporting; monitoring performance using score cards; information security audits, business continuity planning, active involvement in a third-party board or committee, utilization of a news alert service, coordinating public responses and communications using a public relations team, or any other suitable control or combination of controls.

In certain embodiments, the control risk assessment value may be a numeric value (e.g., an integer value ranging from “1” to “5”), with greater values corresponding to greater risk levels. For example, the control risk assessment values may correspond to a control rating scale in which: “5” indicates that there are no means to provide detection and/or escalation of corrective actions when the risk occurs; “4” indicates that there are little means to provide detection and/or escalation of corrective actions in an effective manner when the risk occurs; “3” indicates that there are means to provide manual detection and escalation of corrective actions that are effective most of the time the risk occurs; “2” indicates that there are effective means to provide automatic detection of the risk and manual escalation of corrective actions every time the risk occurs; and “1” indicates that there are very effective means to provide immediate, automatic redetection and correction of the risk every time the risk occurs. In some arrangements, control risk assessment field 309 may include features similar to those described with reference to severity risk assessment field 305. For example, a control risk assessment value may be determined by comparing historical data to a threshold value.

In some embodiments, a user may input a numeric value (e.g., “2,” “3,” “5”) in one or more of risk assessment fields 305, 307, and 309. In some embodiments, a user may input a text value (e.g., “high,” “low,” “remote,” “critical,” etc.) in one or more of risk assessment fields 305, 307, and 309. In some embodiments, user selection of one or more of risk assessment fields 305, 307, and 309 may provide a pop-up window display, drop down display, or any other suitable display that includes a list of pre-defined risk assessment values (e.g., “1” through “5”, “high” through “low”), one of which the user may select to populate the respective risk assessment field. For example, user selection of risk assessment field 309 may provide display region 320 that includes a list of pre-defined risk assessment values (e.g., “5” through “1”). The user may select highlighted risk assessment value 321 (e.g., “5”) to populate risk assessment field 309. Other risk assessment values, indicators, and the like may be used.

In some embodiments, the risk assessment system may receive the risk assessment values input in risk assessment fields 305, 307, and 309 and calculate risk priority value 310 based on the received values. For example, risk priority value 310 may be a risk priority number (RPN) and the risk assessment system may determine risk priority value 310 by multiplying risk assessment values 305, 307, and 309, where each risk assessment value is an integer value ranging from 1 to 5. As a result, risk priority value 310 may have an integer value ranging from 1 to 125, with greater values corresponding to greater risk levels. In another example, the risk assessment system may determine risk priority value 310 using various weight values (e.g., by calculating a weighted sum or weighted average of risk assessment values 305, 307, and 309). In another example, the risk assessment system may utilize linear algebra to determine risk priority values for multiple risk items using a matrix of risk assessment values, a matrix or array of weight values, or any other suitable matrices or arrays. In some embodiments risk priority value 310 may be a text value calculated using risk assessment values from risk assessment fields 305, 307, and 309 as input.

In some embodiments, risk values for risk item 301 may be displayed in accordance with the organization's risk appetite, risk tolerance, or both. Risk appetite indicates the level of uncertainty the organization is willing to assume given the corresponding reward associated with the risk, and risk tolerance indicates the amount of risk the organization is willing and able to keep in executing its business strategy (i.e., the limits of a company's capacity for taking on risk). For example, risk assessment field 309 may be color-coded as red as a result when its risk assessment value reaches a threshold value (e.g., “5”). In another example, the risk assessment system may compare the risk priority value in field 310 against a threshold value. For example, risk priority value 310 may be color-coded as red, yellow, or green when its numeric value is greater than 63, between 28 and 63 (or includes a risk assessment value of “5” in any of fields 305, 307, or 309), or less than 28, respectively. Red and yellow may be indicative of varying degrees of escalation, and green may be indicative of a low or typically acceptable level of risk. In certain embodiments, the threshold value or values may be weighted by the organization's risk appetite, risk tolerance, or both. For example, the threshold range for the color-code red may be increased or decreased (e.g., by a certain amount or percentage) for a particular risk item having a lower or higher risk tolerance level. Other visual coding of a risk level may be used.

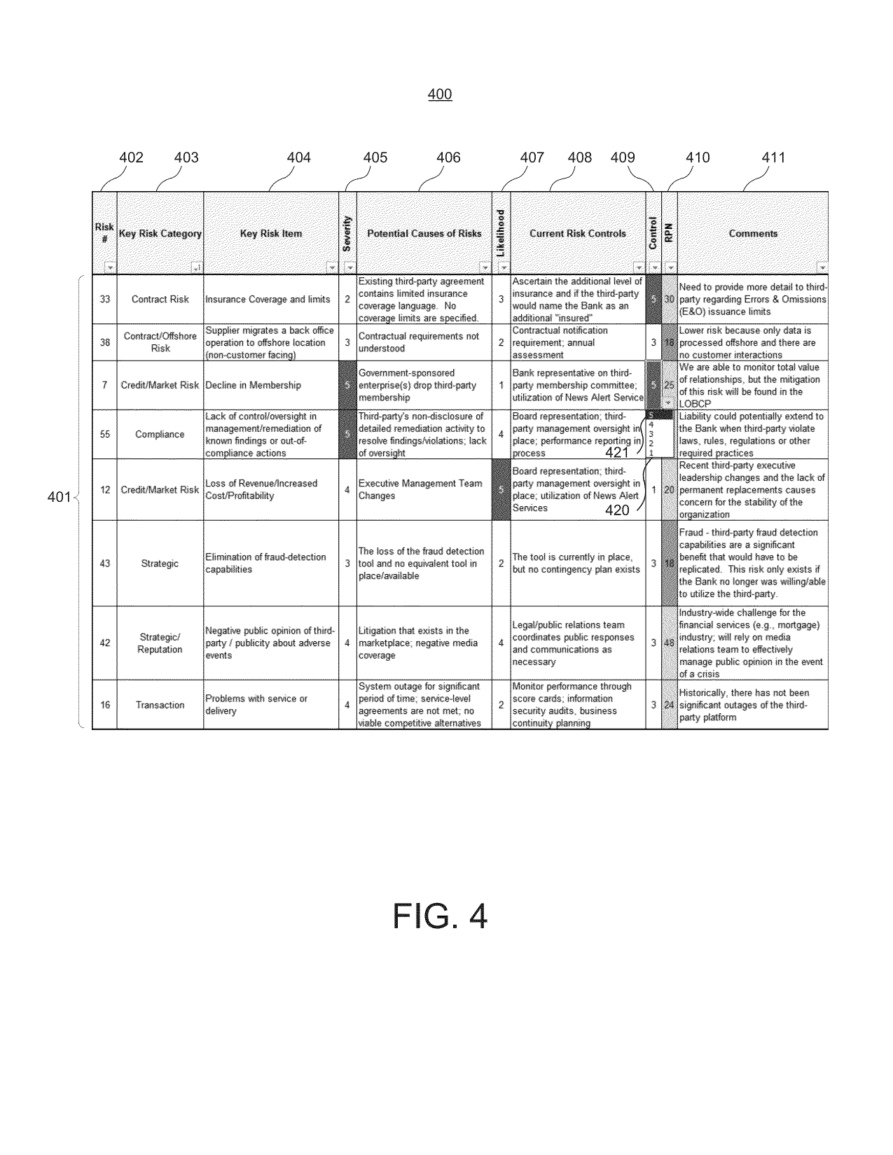

FIG. 4 illustrates an example user interface 400 for providing risk assessment values and determining a risk priority numbers for a plurality of risk items in accordance with some embodiments of the disclosure. User interface 400 may be displayed on workstation 201 shown in FIG. 2 using, for example, display device 117 shown in FIG. 1. User interface 400 may include a plurality of risk items 401, each associated with a respective risk identifier field 402, risk category field 403, risk identification field 404, severity risk assessment field 405, comment field 406 (e.g., “Potential Causes of Risks”), likelihood risk assessment field 407, comment field 408 (e.g., “Current Risk Controls”), control risk assessment field 409, risk priority field 410, and comments field 411.

In some embodiments, selectable risk assessment fields 405, 407, and 409 may include the features described with reference to fields 305, 307, and 309, respectively, shown in FIG. 3. For example, a user may input a numeric value in one or more of risk assessment fields 405, 407, and 409. In another example, user selection of risk assessment field 409 may provide display region 420 that includes a list of pre-defined risk assessment values (e.g., “5” through “1”). The user may select, for example, highlighted risk assessment value 421 (e.g., “5”) to populate risk assessment field 409.

In some embodiments, risk priority value 410 may include the features described with reference to risk priority value 310 shown in FIG. 3. For example, risk priority value 410 may be a numeric value determined by multiplying risk assessment values 405, 407, and 409, with greater values corresponding to greater risk levels. In another example, risk priority value 410 may be color-coded as red, yellow, or green when its numeric value is greater than 63, between 28 and 63 (or includes a risk assessment value of “5” in any of fields 405, 407, or 409), or less than 28, respectively.

In some embodiments, comment fields 406, 408, and 411 may include text input by one or more users (e.g., using workstations 201 shown in FIG. 2), information provided by the risk assessment system (e.g., risk assessment system 204 shown in FIG. 2), information provided by a remote information source (e.g., remote information source 210 shown in FIG. 2), or any other suitable information. For example, comment field 406 may include comments input by a subject matter expert, comment field 408 may include comments provided by a remote or third-party database, and comments field 411 may include comments input by a manager or board member of the organization.

In some embodiments, risk category field 403 may include risk category information associated with each of risk items 401. Risk category information may be provided by a user, the risk assessment system, a remote information source, or any other suitable source. Risk categories associated with third-party relationships may include, for example:
Credit risk—Credit risk is the risk to earnings or capital arising from a third-party's failure to meet the terms of any contract or otherwise to perform as agreed. Credit risk may arise under various third-party scenarios. For example, third parties that market or originate certain types of loans subject the organization to increased credit risk if the organization does not exercise effective due diligence over, and monitoring of, the third-party. Third-party arrangements can have substantial effects on the quality of receivables and other credit performance indicators when the third-party conducts account management, customer service, or collection activities. In another example, substantial credit risk may arise from improper oversight of third parties who solicit and refer customers (e.g., brokers, dealers, merchant processing ISOs, and credit card marketers), conduct underwriting analysis (credit card processing and loan processing arrangements), or set up product programs (overdraft protection, payday lending, and title lending). The credit risk for some of these third-party programs may be shifted back to the organization if the third-party does not fulfill its responsibilities or have the financial capacity to fulfill its obligations. Accordingly, it is important for the organization to assess the financial strength of the third-party and to have a contingency plan in the event the third-party is unable to perform.
Transaction risk—Transaction risk is the risk to earnings or capital arising from problems with the delivery of products or services offered by the third-party. A third-party's inability to deliver products and services, whether arising from fraud, error, inadequate capacity, or technology failure, exposes the organization to transaction risk. For example, transaction risk may increase when the products, services, delivery channels, and processes that are designed or offered by a third-party do not fit with the organization's systems, customer demands, or strategic objectives. Lack of effective business resumption and contingency planning for these situations also increases transaction risk.
Strategic risk—Strategic risk is the risk to earnings or capital arising from adverse business decisions or improper implementation of those decisions. An organization is exposed to strategic risk if it uses third parties to conduct banking functions or offer products and services that are not compatible with the organization's strategic goals or do not provide an adequate return on investment. For example, strategic risk may arise if the organization does not possess adequate expertise and experience to properly oversee the activities of the third-party.
Compliance risk—Compliance risk is the risk to earnings or capital arising from violations of laws, rules, or regulations, or from nonconformance with internal policies and procedures or ethical standards. Compliance risk exists when products, services, or systems associated with the third-party relationship are not properly reviewed for compliance, or when the third-party's operations are not consistent with law, ethical standards, or the organization's policies and procedures. For example, compliance risk may arise when privacy of consumer and customer records is not adequately protected, when conflicts of interest between the organization and affiliated third parties are not appropriately managed, and when the organization or its service providers have not implemented an appropriate information security program.
Reputation risk—Reputation risk is the risk to earnings or capital arising from negative public opinion. Third-party relationships that do not meet the expectations of the organization's customers expose the organization to reputation risk. Poor service, disruption of service, inappropriate sales recommendations, and violations of consumer law can result in litigation, loss of business to the organization, or both. For example, when the third-party's employees interact directly with the organization's customers (e.g., in joint marketing arrangements or from call centers), reputation risk may arise if the interaction is not consistent with the organization's policies and standards. In another example, publicity about adverse events surrounding a third-party may increase reputation risk.
Other risks—Third-party relationships may also subject the organization to liquidity, interest rate, price, and foreign currency translation risk. In addition, an organization may be exposed to country risk when dealing with a foreign-based third-party service provider. Country risk is the risk that economic, social, and political conditions and events in a foreign country will adversely affect the organization's financial interests. Other risks may also include, for example, contractual risks and market risks that may arise from third-party relationships.

In some embodiments, a process within a standard risk framework may be referred to as a risk category. For example, a user may select and input a risk category for one of risk items 401 in risk category field 403 using an input device, such as input device 121 shown in FIG. 1. In another example, the risk assessment system may associate the risk item “Insurance coverage and limits” in risk identification field 404 with the risk category “Contract Risk” in risk category field 403. In certain embodiments, risk category field 403 may include information retrieved from risk assessment system 204 or remote information source 210 shown in FIG. 2, and may or may not be editable by a user. In some embodiments, user selection of risk category field 403 may provide a pop-up window display that includes a list of pre-defined risk identifiers, one of which the user may select to populate identification field 403. This pop-up window display is not shown in FIG. 3 to avoid overcomplicating the drawing.

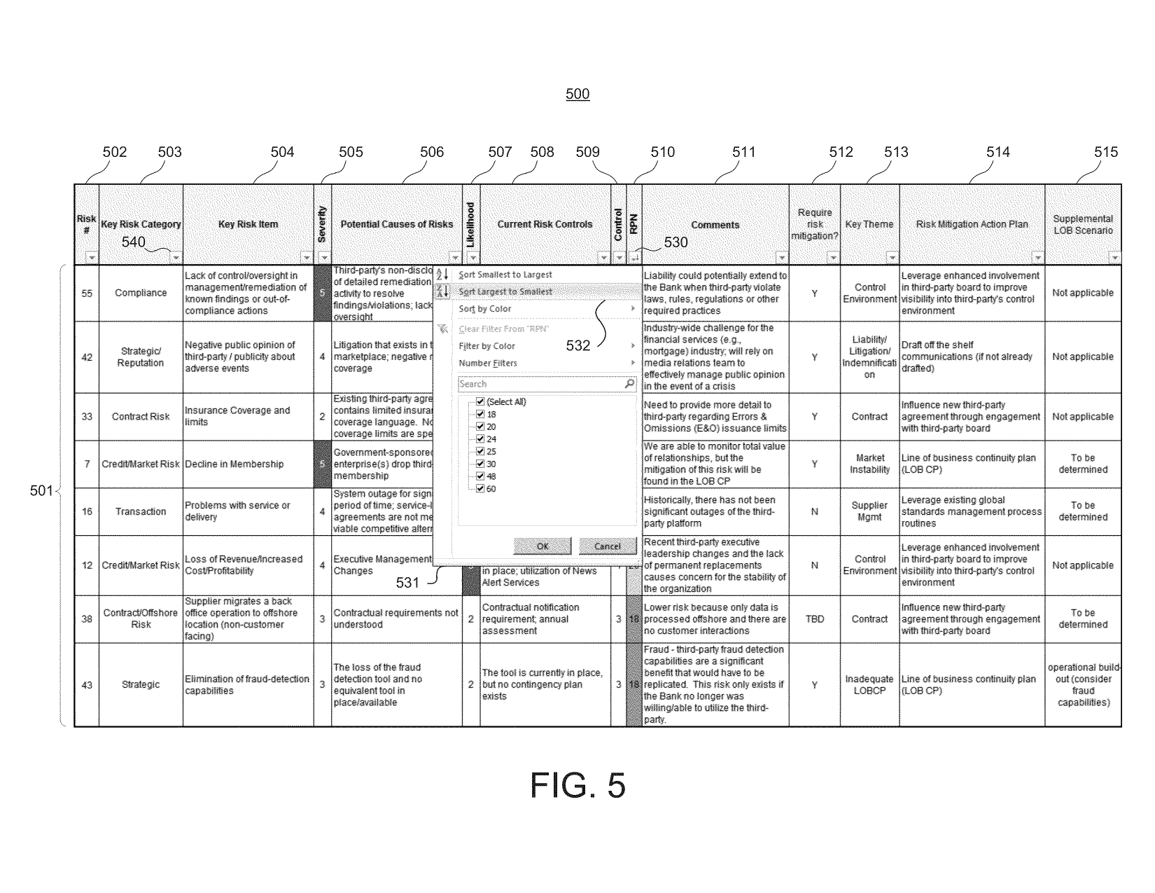

FIG. 5 illustrates an example user interface 500 for prioritizing risk items and identifying risk items for additional risk mitigation in accordance with some embodiments of the disclosure. User interface 500 may be displayed on workstation 201 shown in FIG. 2 using, for example, display device 117 shown in FIG. 1. User interface 500 may include a plurality of risk items 501, each associated with a respective risk identifier field 502, risk category field 503, risk identification field 504, severity risk assessment field 505, comment field 506, likelihood risk assessment field 507, comment field 508, control risk assessment field 509, risk priority field 510, and comments field 511. Any of fields 502-511 may include features similar to those discussed with reference to fields 402-411 shown in FIG. 4.

In some embodiments, risk items 501 may be prioritized, filtered, or both based on their respective risk priority values in risk priority value field 510. For example, user selection of option 530 may provide display region 531 (e.g., a pop-up window display, a drop down display) that includes one or more risk prioritization options. Risk prioritization options may include, for example, “Sort Smallest to Largest,” “Sort Largest to Smallest,” “Sort by Color,” “Filter by Color,” “Number Filters,” a search field, filter-by-value fields, and the confirmation options “OK” and “Cancel.” A user may select one of the risk prioritization options to prioritize risk items 501, filter risk items 501, or both. For example, a user may select highlighted risk prioritization option 532 (e.g., “Sort Largest to Smallest”) to prioritize risk items 501 so that risk items with greater risk priority values are located near the top of user interface 500.

In some embodiments, risk items 501 may be prioritized, filtered, or both based on their respective risk categories. Each risk item may be associated with a risk category, such as, for example, a credit risk category, a transaction risk category, a strategic risk category, a contractual risk category, a market risk category, a reputation risk category, or a combination of risk categories. In certain implementations, each risk category may be associated with a weight value indicating a relative degree of importance to the third-party risk assessment or the overall risk profile of the organization, such as a numerical value ranging from 0.00 to 1.00 where the sum of all of the weighting factors equals 100%. For example, the risk assessment system may calculate weighted risk priority values for risk items 501 by multiplying each of risk item 501's risk priority number with a weight value associated with its risk category and prioritize the risk items based on their respective weighted risk priority values.

In some embodiments, risk items 501 may be partitioned into different risk groups so that risks in each group may be analyzed. For example, risk items 501 may be grouped by risk category (e.g., by name, by weight value, by importance to third-party risk assessment) in response to a user selecting option 540, which may provide a display region with features similar to those discussed with reference to option 530. This display region is not shown in FIG. 5 to avoid overcomplicating the drawing.

In some embodiments, the risk assessment system, a user, or both may evaluate risk items 501 to identify risk items for additional risk mitigation. For example, the risk assessment system may compare the risk priority value in field 510 against a threshold value and identify risk items with risk priority values above the threshold for additional risk mitigation. In another example, the risk assessment system may identify risk items for additional risk mitigation using a six sigma analytical technique. In some embodiments, user interface 500 may include field 512 (e.g., “Require risk mitigation”), in which the risk assessment system may determine whether to identify a risk item for additional risk mitigation (e.g., “Y” for yes) or not (e.g., “N” for no). For example, risk items with a risk priority number greater than 30 or a severity risk assessment value of 5 may be identified for additional risk mitigation. In some embodiments, processes for identifying risk may include or leverage any other suitable information, such as audit and change management routines and regulatory review or examination findings.

In certain implementations, the threshold value may be an average value (e.g., an arithmetic, geometric, or harmonic mean, median, or mode) or a running average value of one or more of the attributes of risk items 501, such as the risk assessment values in fields 505, 507, and 509, the risk priority value in field 510, or any other suitable attribute or combination of attributes. For example, the threshold value may be the arithmetic median value of the risk priority values for risk items 501. In some embodiments, the threshold value may be weighted by the organization's risk appetite, risk tolerance, or any other suitable parameter. For example, a threshold value based on an average of the risk priority values for risk items 501 may be increased by a certain amount or percentage for an organization with a lower risk tolerance level for third-party risks. In another example, risk items associated with particular risk categories may have different threshold values in response to, for example, one risk category being assigned a lower or higher risk tolerance than another risk category.

In some embodiments, the risk assessment system, a user, or both may evaluate risk items 501 to identify risk items for additional risk mitigation using a six sigma analytical technique. For example, the risk assessment system may analyze risk items 501 by applying a Failure Modes and Effects Analysis (FMEA) to anticipate risks and identify potential failures for which the organization may develop controls to prevent from occurring. An FMEA is an operations management procedure that analyzes failure modes within a process (or a system of processes) in order to classify such failure modes by severity, determine their effects on the process, or both. As used within FMEA, failure modes may include any actual or potential defects or errors in the process (i.e., process, product, design, function, service, project or similar component of the organization's business) being analyzed. Identifying potential failures may include, for example, analyzing various aspects of the failures in order to prioritize the failures and maximize the efficiency with which the failures are addressed. For example, potential failures may undergo a risk versus reward analysis to determine whether some potential failures are not worth putting additional resources towards to detect, mitigate or prevent. Additionally, one or more potential failures may be determined to have escalating odds of actually occurring or increased difficulty in detecting while other potential failures are found to have very small chances of causing problems within the processes to which they are associated or causing problems that do not impact customers in any harmful way.

In some embodiments, user interface 500 may include theme field 513, which may include key risk themes associated with each of risk items 501. Theme field 513 may provide information received from the risk assessment system, a user, or a remote information source in accordance with some embodiments of the disclosure. For example, theme field may include one of the following themes: control environment; liability; litigation; indemnification; contract; market instability; supplier management; control environment; contract; inadequate line of business continuity plan (LOB CP); and any other suitable theme or combination of themes.

In some embodiments, user interface 500 may include risk mitigation action plan field 514. For example, the risk assessment system may determine a risk mitigation action plan for a risk item based on risk attributes 502-513. In one example, the risk mitigation action plan summary for mitigating the risk may be input by a user as free-format text in field 514. In another example, the risk mitigation action plan summary in field 514 may be automatically provided by the risk assessment system (e.g., the identified risk may be associated with a pre-defined or known risk mitigation action plan that may have mitigated the impact of the risk in the past) and may or may not be editable by a user. In another example, user selection of risk mitigation action plan field 514 may provide a pop-up window display, drop down display, or any other suitable display region that includes a list of pre-defined risk mitigation action plans, one of which the user may select to populate risk mitigation action plan field 514. In certain implementations, the user may select risk mitigation action plan field 514 to edit the content of the risk mitigation action plan. This display region is not shown in FIG. 5 to avoid overcomplicating the drawing.

In some embodiments, the risk assessment system may assign a risk assessment mitigation plan and its corresponding risk items to a particular processing module, user, or both for remediation. The risk assessment system may monitor the progress of the assigned remediation task at any suitable frequency (e.g., quarterly, annually). In certain implementations, the risk assessment system may assign a risk item to more than one risk assessment mitigation plans and monitor the progress of mitigating the risk item in each of the assigned risk assessment mitigation plans.

In some embodiments, the risk assessment system may determine a risk mitigation metric for each of the risk assessment mitigation plans to which a risk item is assigned (e.g., a risk item may be assigned to one or more risk mitigation action plans). The risk mitigation metric may be, for example, an integer value ranging from “1” to “5,” with greater values corresponding to greater mitigation effectiveness. In another example, the risk mitigation metric may be a text value ranging from “low” to “high,” with escalating values corresponding to greater mitigation effectiveness. In another example, the risk mitigation metric may be percentage value ranging from “0%” to “100%,” with greater values corresponding to greater mitigation effectiveness. In some embodiments, the risk assessment system may compare the risk mitigation metrics to identify a preferred risk mitigation action plan for the risk item. For example, the risk assessment system may store the risk mitigation plan with the greatest risk metric value in a database of risk items, risk mitigation action plans, and associations thereof (e.g., database 207 shown in FIG. 2). In certain implementations, the risk assessment system may detect a new risk item and search the database of risk items and risk mitigation action plans to identify a preferred risk mitigation action plan for the risk item. If a preferred risk mitigation plan for the risk item is found, the risk assessment system may automatically associate the preferred risk mitigation action plan with the new risk item. For example, the risk assessment system may automatically populate field 514 for the new risk item with a preferred risk mitigation action plan that may have mitigated the impact of the risk item most effectively in the past.

In some embodiments, the risk assessment system may identify a risk as acceptable or unacceptable based on a comparison of its RPN and a threshold value. For example, when a risk priority value is greater than the threshold value, the risk assessment system may identify the corresponding risk item as an unacceptable risk. In some embodiments, unacceptable risk items may be grouped into a risk mitigation action plan. For example, the risk assessment system may group unacceptable risk items together according to a predefined reporting format and generate a report to an outside agency based on the unacceptable risk items.

In some embodiments, user interface 500 may include supplemental line of business (LOB) scenario field 515. An LOB may have primary accountability for its third-party risk management and select representatives to drive risk identification, prioritization, escalation and mitigation for third-party business compliance, information security/business continuity, program execution, technological, and risks associated with risk category field 503. For example, representatives may be voting members of a risk and compliance steering committee.

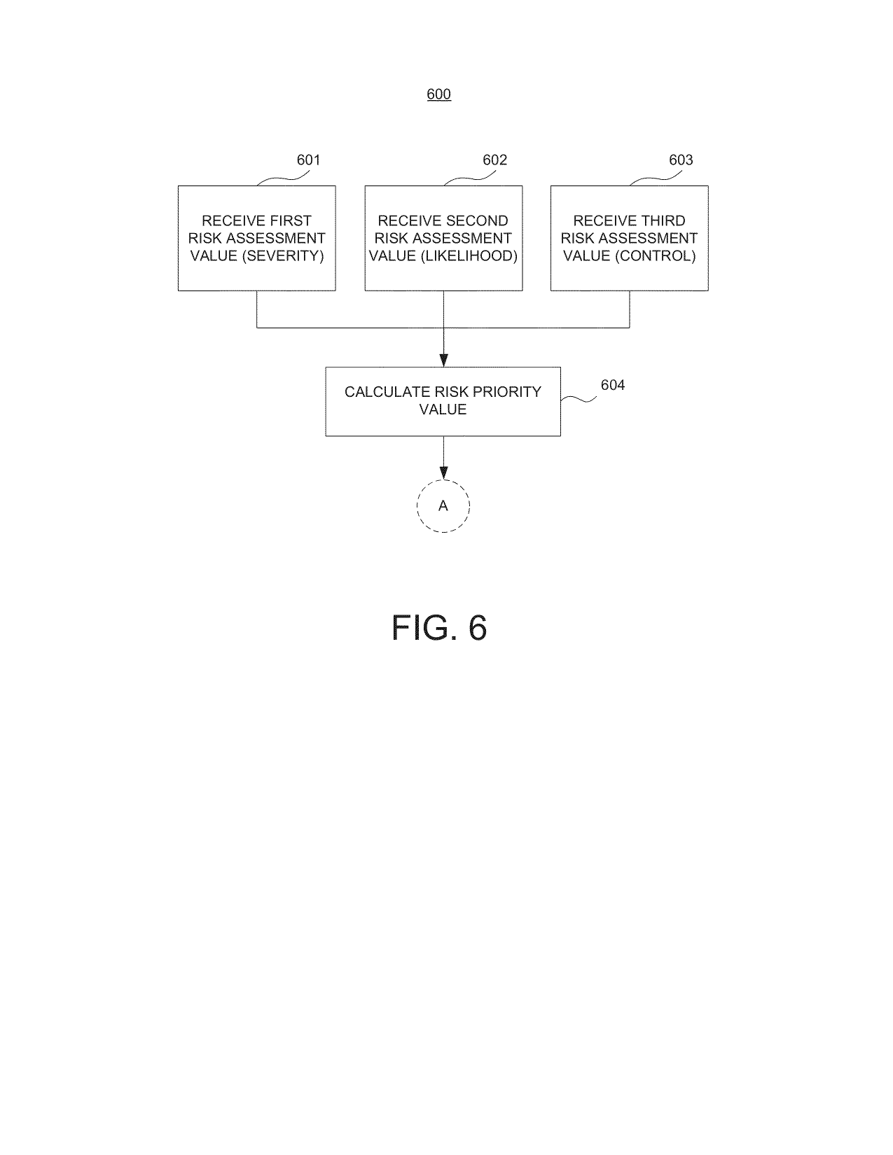

FIG. 6 is a flowchart illustrating example process 600 for determining a risk priority value for a risk item in accordance with some embodiments of the disclosure.

At step 601, the risk assessment system (e.g., risk assessment system 204 shown in FIG. 2) receives a first risk assessment value. The first risk assessment value may be a numerical value indicative of the severity of the risk item, such as a severity risk assessment value discussed with reference to severity risk assessment field 305 shown in FIG. 3. For example, the first risk assessment value may be a severity risk assessment value determined by and received from risk assessment system 204 shown in FIG. 2. The risk assessment system 204 may determine a category or type of risk item associated with the assessment value and generate a risk assessment value by averaging risk assessment values previously assigned to the similar risk items in the same category or of the same type. In another example, the first risk assessment value may be a severity risk assessment value input by a user in severity risk assessment field 305 shown in FIG. 3 using, for example, input device 121 shown in FIG. 1.

At step 602, the risk assessment system receives a second risk assessment value. The second risk assessment value may be a numerical value indicative of the likelihood of the risk item, such as a likelihood risk assessment value discussed with reference to likelihood risk assessment field 307 shown in FIG. 3. For example, the second risk assessment value may be a likelihood risk assessment value determined by and received from risk assessment system 204 shown in FIG. 2. The risk assessment system 204 may, for instance, compare the category or type of the risk item and generate a likelihood risk assessment value by averaging likelihood risk assessment values previously assigned to the similar risk items in the same category or of the same type. In some examples, the system 204 may select one of the previously defined risk items and define the present likelihood risk assessment value based on that the likelihood risk assessment value assigned to that one previously defined risk item. Alternatively or additionally, the second risk assessment value may be a likelihood risk assessment value input by a user in likelihood risk assessment field 307.

At step 603, the risk assessment system receives a third risk assessment value. The third risk assessment value may be a numerical value indicative of the control of the risk item, such as a control risk assessment value discussed with reference to control risk assessment field 309 shown in FIG. 3. For example, the third risk assessment value may be a control risk assessment value determined by and received from risk assessment system 204 shown in FIG. 2. Similar to the likelihood risk assessment value, the risk assessment system 204 may compare a category or type of the risk item with other previously defined risk items and generate a control risk assessment value by averaging control risk assessment values previously assigned to the similar risk items in the same category or of the same type. Alternatively or additionally, the third risk assessment value may be a control risk assessment value input by a user in control risk assessment field 309.

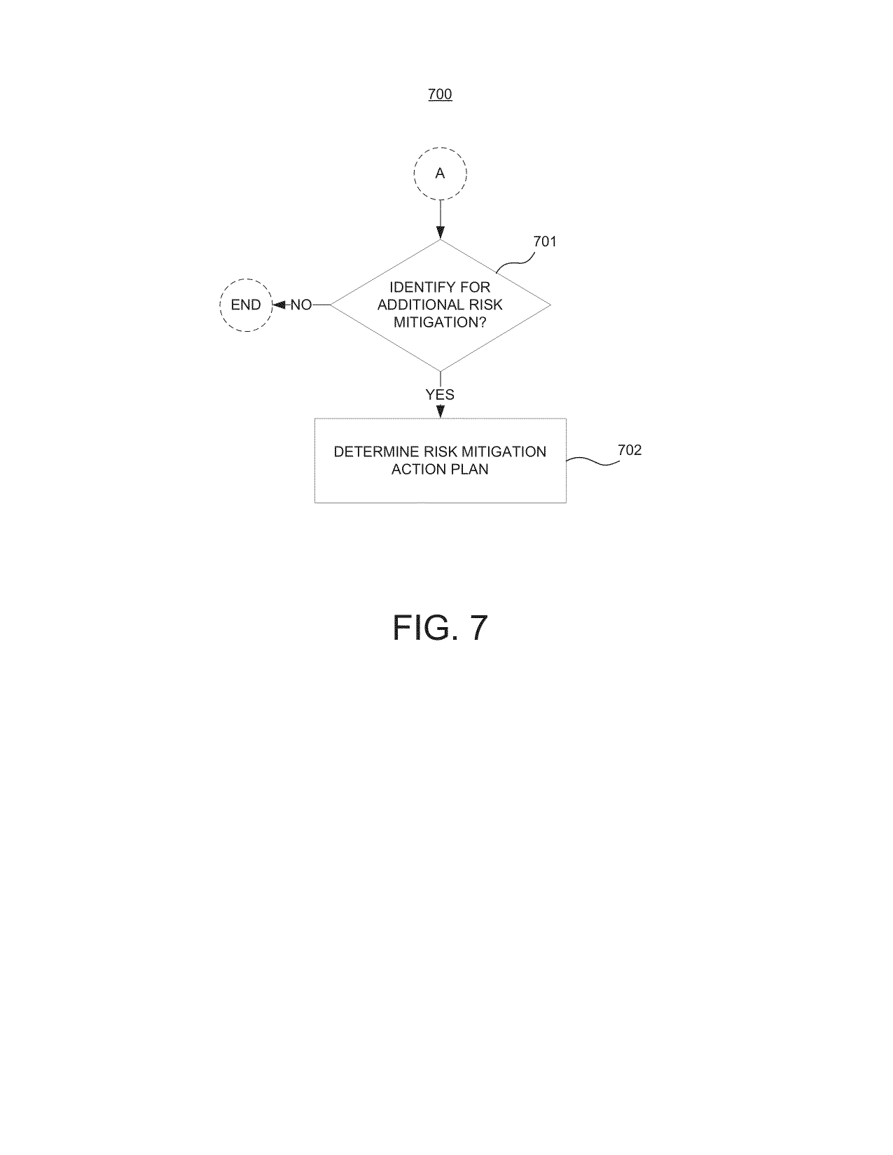

At step 604, the risk assessment system calculates a risk priority value based on the first, second, and third risk assessment values. In certain embodiments, the risk priority value may be an RPN determined by calculating the mathematical product of the risk assessment values. For example, the risk assessment system may calculate risk priority value 310 shown in FIG. 3 by multiplying risk assessment values 305, 307, and 309, where each risk assessment value is an integer value ranging from 1 to 5. As a result, the risk priority value may have an integer value ranging from 1 to 125, with greater values corresponding to greater risk levels. In another example, the risk assessment system may determine the risk priority value using various weight values (e.g., by calculating a weighted sum or weighted average of risk assessment values 305, 307, and 309). In another example, the risk assessment system may utilize linear algebra to determine risk priority values for multiple risk items using a matrix of risk assessment values, a matrix or array of weight values, or any other suitable matrices or arrays. In some embodiments, the risk priority value may be a text value determined using the risk assessment values as input to any suitable computing process or instructions. After step 604, process 600 may proceed to optional step A, which is described further with reference to FIG. 7. FIG. 7 is a flowchart illustrating example process 700 for determining whether or not to identify a risk item for additional risk mitigation in accordance with some embodiments of the disclosure.

At step 701, the risk assessment system (e.g., risk assessment system 204 shown in FIG. 2) determines whether or not to identify a risk item for additional risk mitigation. For example, the risk assessment system may compare a risk priority value (e.g., an RPN in field 510 shown in FIG. 5) to a threshold value and identify the risk item for additional risk mitigation when its risk priority value is greater than the threshold value (e.g., as indicated in field 512). In an example, the risk assessment system may identify risk items with a risk priority number greater than 30 or a severity risk assessment value of 5 for additional risk mitigation. In another example, the risk assessment system may identify risk items for additional risk mitigation using a six sigma analytical technique (e.g., a six sigma analytical technique that leverages the concept of an FMEA). In certain implementations, the determination may be partially or wholly based on input received from a user (e.g., using input device 121 shown in FIG. 1). If the risk assessment system does not identify the risk item for additional risk mitigation, process 700 ends. If the risk assessment system identifies the risk item for additional risk mitigation, process 700 proceeds to step 702.

At step 702, the risk assessment system determines a risk mitigation action plan for the risk item. For example, the risk assessment system may determine a risk mitigation action plan for a risk item in risk mitigation action plan field 514 shown in FIG. 5 based on risk attributes 502-513. In certain implementations, the risk mitigation action plan may be partially or wholly based on input received from a user (e.g., using input device 121 shown in FIG. 1). For example, the risk mitigation action plan for mitigating the risk may be input by a user as free-format text in field 514. In certain implementations, the risk assessment system may automatically provide the risk mitigation action plan. For example, the identified risk may be associated with a pre-defined or known risk mitigation action plan that may have mitigated the impact of the risk in the past. In another example, the risk assessment system may determine the risk mitigation action plan in response to a user selecting a risk mitigation action plan from among a list of pre-defined risk mitigation action plans and, in some implementations, editing the content of the pre-defined risk mitigation action plan.

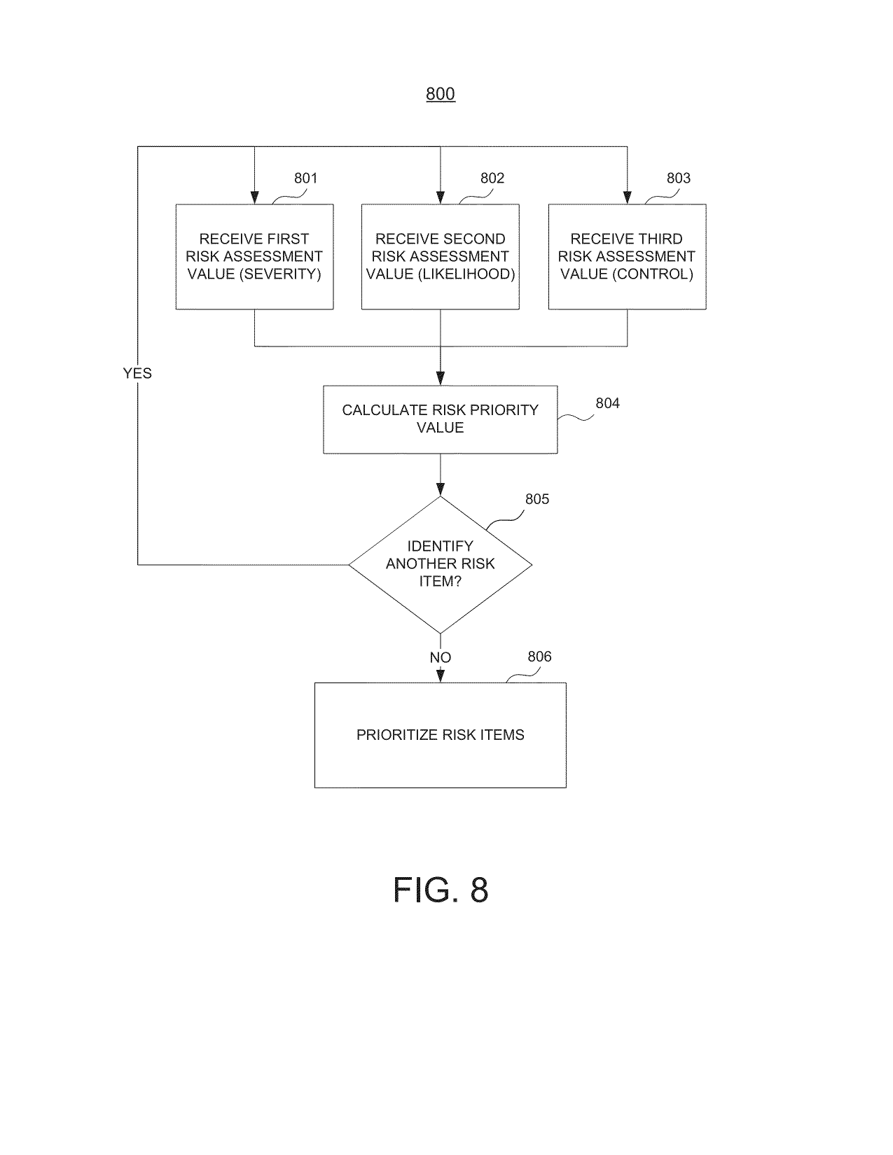

FIG. 8 is a flowchart illustrating an example method for prioritizing risk items in accordance with some embodiments of the disclosure.

At step 801, the risk assessment system (e.g., risk assessment system 204 shown in FIG. 2) receives a first risk assessment value. The first risk assessment value may be a numerical value indicative of the severity of the risk item, such as a severity risk assessment value discussed with reference to severity risk assessment field 305 shown in FIG. 3. For example, the first risk assessment value may be a severity risk assessment value determined by and received from risk assessment system 204 shown in FIG. 2. In another example, the first risk assessment value may be a severity risk assessment value input by a user in severity risk assessment field 305 shown in FIG. 3 using, for example, input device 121 shown in FIG. 1.

At step 802, the risk assessment system receives a second risk assessment value. The second risk assessment value may be a numerical value indicative of the likelihood of the risk item, such as a likelihood risk assessment value discussed with reference to likelihood risk assessment field 307 shown in FIG. 3. For example, the second risk assessment value may be a likelihood risk assessment value determined by and received from risk assessment system 204 shown in FIG. 2. In another example, the second risk assessment value may be a likelihood risk assessment value input by a user in likelihood risk assessment field 307.

At step 803, the risk assessment system receives a third risk assessment value. The third risk assessment value may be a numerical value indicative of the control of the risk item, such as a control risk assessment value discussed with reference to control risk assessment field 309 shown in FIG. 3. For example, the third risk assessment value may be a control risk assessment value determined by and received from risk assessment system 204 shown in FIG. 2. In another example, the third risk assessment value may be a control risk assessment value input by a user in control risk assessment field 309 shown in FIG. 3.

At step 804, the risk assessment system calculates a risk priority value based on the first, second, and third risk assessment values. In certain embodiments, the risk priority value may be an RPN determined by calculating the mathematical product of the risk assessment values (e.g., as described with reference to risk priority value 310 shown in FIG. 3). In another example, the risk assessment system may determine the risk priority value using various weight values (e.g., by calculating a weighted sum or weighted average of risk assessment values 305, 307, and 309). In another example, the risk assessment system may utilize linear algebra to determine risk priority values for multiple risk items using a matrix of risk assessment values, a matrix or array of weight values, or any other suitable matrices or arrays. In some embodiments, the risk priority value may be a text value determined using the risk assessment values as input to any suitable computing process or instructions.

At step 805, the risk assessment system determines whether or not another risk item is identified for assessment (e.g., to receive risk assessment values, to calculate a risk priority value). For example, the risk assessment system may process risk items 501 shown in FIG. 5 to determine whether or not all of the risk items have been assessed and all RPNs have been calculated. If the risk assessment system identifies another risk item for assessment, process 800 proceeds to steps 801, 802, and 803. If the risk assessment system does not identify another risk item for assessment, process 800 proceeds to step 806.

At step 806, the risk assessment system prioritizes the risk items. The risk assessment system may prioritize risk items based on their respective risk priority values (e.g., an RPN in risk priority value field 510 shown in FIG. 5), their respective risk categories (e.g., a risk category in risk category field 503 shown in FIG. 5), or both. For example, the risk assessment system may prioritize risk items 501 shown in FIG. 5 in response to a user selecting highlighted risk prioritization option 532 (e.g., “Sort Largest to Smallest”) using, for example, input device 121 shown in FIG. 1. In another example, the risk assessment system may calculate weighted risk priority values for risk items 501 by multiplying each risk item's risk priority number with a weight value associated with its risk category and prioritize the risk items based on their respective weighted risk priority values.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disk storage, magnetic cassettes, magnetic tape, magnetic storage and the like. The computer readable instructions may be executed by one or more processors (e.g., multi-core processor or multi-processor systems) to cause a system or apparatus, such as a computing device, to perform various tasks, functions, or both in accordance with some embodiments of the disclosure.

While illustrative systems and methods as described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the disclosure. The description is thus to be regarded as illustrative instead of restrictive on the disclosure.

We claim:

1. A method comprising:
receiving, at a computing device, a first risk assessment value indicative of an assessment of a severity of a risk item;
receiving, at the computing device, a second risk assessment value indicative of an assessment of a likelihood of the risk item;
receiving, at the computing device, a third risk assessment value indicative of an assessment of a control for the risk item; and
determining, at the computing device, a risk priority value based on the first risk assessment value, the second risk assessment value, and the third risk assessment value.

2. The method of claim 1, wherein determining the risk priority value comprises determining a risk priority number based on a mathematical product of the first risk assessment value, the second risk assessment value, and the third risk assessment value.

3. The method of claim 1, wherein each of the first risk assessment value, the second risk assessment value, and the third risk assessment value is received in response to input from a user.

4. The method of claim 1, further comprising determining whether or not to identify the risk item for additional risk mitigation based on a comparison of the risk priority value and a threshold value.

5. The method of claim 4, further comprising, in response to determining to identify the risk item for additional risk mitigation, determining a risk mitigation action plan for the risk item.

6. The method of claim 1, further comprising color-coding the risk priority value based on a comparison of the risk priority value and a threshold value.

7. The method of claim 1, further comprising:
receiving, at the computing device, a plurality of first risk assessment values respectively corresponding to a plurality of risk items;
receiving, at the computing device, a plurality of second risk assessment values respectively corresponding to the plurality of risk items;
receiving, at the computing device, a plurality of third risk assessment values respectively corresponding to the plurality of risk items;
determining, at the computing device, a risk priority value for each of the plurality of risk items based on the respective first risk assessment value, the respective second risk assessment value, and the respective third risk assessment value; and
prioritizing the plurality of risk items based on the respective risk priority values.

8. The method of claim 7, wherein:
each of the plurality of risk items is associated with a respective risk category comprising a respective weight value;
the respective risk category is a risk category selected from the group of a credit risk category, a transaction risk category, a strategic risk category, a contractual risk category, a market risk category, a reputation risk category, and a combination thereof; and
prioritizing the plurality of risk items further comprises prioritizing the plurality of risk items based on the respective risk priority value and the respective weight value.

9. The method of claim 7, further comprising identifying, using a six sigma analytical technique, a subset of the plurality of risk items for additional risk mitigation.

10. A system comprising:
a processor; and
a memory storing computer readable instructions that, when executed by the processor, cause the system to:
receive a first risk assessment value indicative of an assessment of a severity of a risk item;
receive a second risk assessment value indicative of an assessment of a likelihood of the risk item;
receive a third risk assessment value indicative of an assessment of a control for the risk item; and
determine a risk priority value based on the first risk assessment value, the second risk assessment value, and the third risk assessment value.

11. The system of claim 10, wherein the memory stores computer readable instructions that, when executed by the processor, cause the system to determine a risk priority number based on a mathematical product of the first risk assessment value, the second risk assessment value, and the third risk assessment value.

12. The system of claim 10, wherein each of the first risk assessment value, the second risk assessment value, and the third risk assessment value is received in response to input from a user.

13. The system of claim 10, wherein the memory stores computer readable instructions that, when executed by the processor, cause the system to determine whether or not to identify the risk item for additional risk mitigation based on a comparison of the risk priority value and a threshold value.

14. The system of claim 13, wherein the memory stores computer readable instructions that, when executed by the processor, cause the system to, in response to determining to identify the risk item for additional risk mitigation, determine a risk mitigation action plan for the risk item.

15. The system of claim 10, wherein the memory stores computer readable instructions that, when executed by the processor, cause the system to color-code the risk priority value based on a comparison of the risk priority value and a threshold value.

16. The system of claim 10, wherein the memory stores computer readable instructions that, when executed by the processor, cause the system to:
receive a plurality of first risk assessment values respectively corresponding to a plurality of risk items;
receive a plurality of second risk assessment values respectively corresponding to the plurality of risk items;
receive a plurality of third risk assessment values respectively corresponding to the plurality of risk items;
determine a risk priority value for each of the plurality of risk items based on the respective first risk assessment value, the respective second risk assessment value, and the respective third risk assessment value; and
prioritize the plurality of risk items based on the respective risk priority values.

17. The system of claim 16, wherein:
each of the plurality of risk items is associated with a respective risk category comprising a respective weight value;
the respective risk category is a risk category selected from the group of a credit risk category, a transaction risk category, a strategic risk category, a contractual risk category, a market risk category, a reputation risk category, and a combination thereof; and
the memory stores computer readable instructions that, when executed by the processor, cause the system to prioritize the plurality of risk items based on the respective risk priority value and the respective weight value.

18. The system of claim 16, wherein the memory stores computer readable instructions that, when executed by the processor, cause the system to identify, using a six sigma analytical technique, a subset of the plurality of risk items for additional risk mitigation.

19. A non-transitory computer readable storage medium storing computer readable instructions which, when read by a computer, instruct the computer to perform steps comprising:
receiving a first risk assessment value indicative of an assessment of a severity of a risk item;
receiving a second risk assessment value indicative of an assessment of a likelihood of the risk item;
receiving a third risk assessment value indicative of an assessment of a control for the risk item; and
determining a risk priority value based on the first risk assessment value, the second risk assessment value, and the third risk assessment value.

20. The non-transitory computer readable storage medium of claim 19, wherein determining the risk priority value comprises determining a risk priority number based on a mathematical product of the first risk assessment value, the second risk assessment value, and the third risk assessment value.
